(19) United States
(12) Patent Application Publication
(10) Pub. No.: US 2011/0030357 A1
(43) Pub. Date: Feb. 10, 2011

(54) GAS FILTER STRUCTURE HAVING A VARIABLE WALL THICKNESS

(75) Inventors: Adrien Vincent, Cabannes (FR); Fabiano Rodrigues, Roussillon (FR); Atanas Chapkov, Caumont Sur Durance (FR); David Lechevalier, Cambridge, MA (US); Vignesh Rajamani, Marlborough, MA (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN CENTRE DE RECHERCHES ET D'ET EUROPEEN, Courbevoie (FR)

(21) Appl. No.: 12/920,548

(22) PCT Filed: Mar. 10, 2009
(86) PCT No.: PCT/FR2009/050383

§ 371 Date: Sep. 1, 2010

(30) Foreign Application Priority Data
Mar. 11, 2008 (FR) 0851580

(51) Int. Cl. F01N 3/02; B01D 46/00

(52) U.S. Cl. 60/311; 55/476

(57) ABSTRACT

The invention relates to a gas filter structure for filtering particulate-laden gases, of the honeycomb type and comprising an assembly of longitudinal adjacent channels of mutually parallel axes separated by porous filtering walls, said channels being alternately blocked off at one or the other of the ends of the structure so as to define inlet channels and outlet channels for the gas to be filtered and so as to force said gas to pass through the porous walls separating the inlet and outlet channels, said structure being characterized in that the inlet and outlet channels share between them at least one wall of constant average thickness d over the entire length of the filter structure, in that the inlet or outlet channels share between them at least one wall of constant average thickness e over the entire length of the filter structure and in that the e/d ratio is strictly greater than 1.

The invention relates to the field of filtering structures that may possibly include a catalytic component, for example those used in an exhaust line of a diesel internal combustion engine.

Filters for the treatment of gases and for eliminating soot particles typically coming from a diesel engine are well known in the prior art. Usually these structures all have a honeycomb structure, one of the faces of the structure allowing entry of the exhaust gases to be treated and the other face allowing exit of the treated exhaust gases. The structure comprises, between the entry and exit faces, an assembly of adjacent ducts or channels, usually square in cross section, having mutually parallel axes separated by porous walls. The ducts are closed off at one or the other of their ends so as to define inlet chambers opening onto the entry face and outlet chambers opening onto the exit face. The channels are alternately closed off in such an order that the exhaust gases, in the course of their passage through the honeycomb body, are forced to pass through the sidewalls of the inlet channels for rejoining the outlet channels. In this way, the particulates or soot particles are deposited and accumulate on the porous walls of the filter body.

Currently, filters made of porous ceramic material, for example cordierite or alumina, especially aluminum titanate, mullite or silicon nitride or a silicon/silicon carbide mixture or silicon carbide, are used for gas filtration.

During its use, it is known that particulate filters are subjected to a succession of filtration (soot accumulation) and regeneration (soot elimination) phases. During the filtration phases, the soot particles emitted by the engine are retained and deposited inside the filter. During the regeneration phases, the soot particles are burnt off inside the filter, so as to restore its filtering properties. The porous structure is therefore subjected to intense radial and tangential thermo-mechanical stresses that may result in micro-cracks liable, over the duration, to result in the unit suffering a severe loss of filtration capacity, or even its complete deactivation. This phenomenon is observed in particular in large-diameter monolithic filters.

To solve these problems and increase the lifetime of the filters, it was proposed more recently to provide filter structures made up from combining several honeycomb blocks or monoliths. The monoliths are usually bonded together by means of an adhesive or cement of ceramic nature, hereafter in the description called joint cement. Examples of such filtering structures are for example described in the patent applications EP 816 065, EP 1 142 619, EP 1 455 923, WO 2004/090294 or WO 2005/063462. To ensure optimum relaxation of the stresses in such an assembled structure, it is known that the thermal expansion coefficients of the various parts of the structure (filter monoliths, coating cement, joint cement) must be substantially of the same order of magnitude. Consequently, said parts are advantageously synthesized on the basis of the same material, usually silicon carbide SiC or cordierite. This choice also ensures uniform heat distribution during regeneration of the filter.

To obtain the best performance in terms of thermo-mechanical strength and pressure drop, the assembled filters currently available for light vehicles typically comprise about 10 to 20 monoliths having a square or rectangular cross section, the elementary cross-sectional area of which is between about 13 cm² and about 25 cm². These monoliths consist of a plurality of channels usually of square cross section. To further reduce the mass of the filter without reducing its performance in terms of pressure drop and soot storage, one obvious solution would be to reduce the number of monoliths in the assembly by increasing their individual size. Such an increase is, however, not currently possible, in particular with SiC filters, without unacceptably reducing the thermo-mechanical strength of the filter.

The filters of larger cross section, currently used in particular for “lorry” applications, are produced by assembling, by means of a jointing cement, monoliths having a size similar to those constituting the filters intended for light vehicles. The number of monoliths of lorry filter type is then very high and may comprise up to 30 or even 80 monoliths. Such filters then have an excessively high overall weight and too high a pressure drop.

In general, there is therefore at the present time a need to increase both the overall filtration performance and the lifetime of current filters.

More precisely, the improvement of filters may be directly measured by comparing the properties that follow, the best possible compromise between these properties being sought according to the invention for equivalent engine speeds. In particular, the subject of the present invention is a filter or a filter monolith having, all at the same time:

a low pressure drop caused by the filtering structure in operation, i.e. typically when it is in an exhaust line of an internal combustion engine, both when such structure is free of soot particles (initial pressure drop) and when it is laden with particles;

a reasonable increase in the pressure drop of the filter during said operation, i.e. an increase in the pressure drop measured as a function of the operating time or more precisely as a function of the level of soot loading of the filter;

a high specific surface area for filtration;

a monolith mass suitable for ensuring a sufficient thermal mass for minimizing the maximum regeneration temperature and the thermal gradients undergone by the filter, which may themselves induce cracks in the monolith;

a soot storage volume, especially at constant pressure drop, so as to reduce the frequency of regeneration;

a high thermo-mechanical strength, i.e. allowing a prolonged lifetime of the filter; and

a higher residue storage volume.

To improve one or the other of the properties described above, it has already been proposed in the prior art to modify the shape of the channels of the filtering structure in various ways.

For example, to increase the filtration surface area of said filter for a constant filter volume, patent application WO 05/016491 proposed filter monoliths in which the inlet and outlet channels are of different shape and different internal volume. In such structures, the wall elements follow one another in cross section and along a horizontal and/or vertical row of channels so as to define a sinusoidal or wavy shape. The wall elements form a wave typically with a sinusoidal half-period over the width of a channel. Such channel configurations make it possible to obtain a low pressure drop and a high soot storage volume. However, this type of structure has a high soot loading slope and the filters produced with this type of channel configuration therefore do not meet all the requirements defined above.

According to another solution described for obtaining improved filtering structures, application EP 1 495 791 teaches structures in which the inlet channels have an overall octagonal cross section, the outlet channels being of square cross section. However, the trials carried out by the applicant have shown that such structures exhibited a substantially degraded compromise between thermo-mechanical strength and pressure drop caused by such a filter in the exhaust line.

Although each of the configurations of the prior art does improve at least one of the desired properties, none of the solutions described therefore provides an acceptable compromise between the set of desired properties, as explained above. In general, it may be pointed out that, for each of the configurations of the prior art, an improvement obtained for one of the properties of the filter is accompanied at the same time by a deterioration in another, so that the improvement finally obtained is generally minor as regards the induced drawbacks.

Thus, the object of the present invention is to provide a filtering structure having the best compromise between induced pressure drop, mass, total filtration surface area, soot and residue storage volume and thermo-mechanical strength, as described above.

In its most general form, the present invention relates to a gas filter structure for filtering particulate-laden gases, of the honeycomb type and comprising an assembly of longitudinal adjacent channels of mutually parallel axes separated by porous filtering walls, said channels being alternately blocked off at one or the other of the ends of the structure so as to define inlet channels and outlet channels for the gas to be filtered and so as to force said gas to pass through the porous walls separating the inlet and outlet channels, said structure being characterized in that:

the inlet and outlet channels share between them at least one wall of constant average thickness d over the entire length of the filter structure;

the inlet or outlet channels share between them at least one wall of constant average thickness e over the entire length of the filter structure; and

the e/d ratio is strictly greater than 1.

Preferably, the filtering structure is such that:

each outlet channel is formed from at least three walls of substantially identical width a, so as to form a channel having a cross section of substantially regular shape;

each outlet channel has a common wall with several inlet channels, each common wall constituting one side of said outlet channel; and

at least two inlet channels share a common wall of width b and average thickness e.

According to one possible embodiment, the inlet and outlet channels are of hexagonal shape.

According to another embodiment, the inlet channels are of triangular shape and the outlet channels are of hexagonal shape.

According to a third possible embodiment, the inlet channels are of octagonal shape and the outlet channels are of square shape.

The terms “triangular”, “square”, “hexagonal” and “octagonal” are understood within the context of the present invention to mean that the channels have, in cross section, an overall shape that can be inscribed in a polygon having 3, 4, 6 and 8 sides respectively.

Preferably, the ratio of the thicknesses e/d is greater than 1 but less than or equal to 10, preferably equal to or greater than 1.05 but less than or equal to 4, more preferably greater than or equal to 1.1 but less than or equal to 2 and even more preferably equal to or greater than 1.1 but less than or equal to 1.5.

According to one possible embodiment, the constituent walls of the inlet and outlet channels are plane.

According to an alternative embodiment, the constituent walls of the inlet and/or outlet channels are wavy, i.e. they have, in cross section and relative to the center of a channel, at least one concavity or at least one convexity.

For example, the outlet channels have walls that are convex relative to the center of said outlet channels. Without departing from the invention, the outlet channels may have walls that are concave relative to the center of said outlet channels. The maximum distance, over a cross section, between an extreme point on the concave or convex wall(s) and the straight segment connecting the two ends of said wall is typically greater than 0 but less than 0.5a.

Preferably, the thickness d is constant over the entire width a of the common walls between the inlet and outlet channels and/or the thickness e is constant over the entire width b of the common walls between the inlet channels.

These thicknesses d and/or e may also have, in cross section, a variable thickness, it being understood that the ratio of the average thickness d to the average thickness e remains strictly greater than 1. More precisely, it is possible, without departing from the scope of the invention, for the e/d ratio not to be always greater than 1 throughout the entire volume of the filter provided that said e/d ratio remains overall greater than 1 when it is integrated over the widths a and b of the corresponding walls.

Advantageously, the channels, preferably the outlet channels, may have rounded corners so as to further reduce the pressure drop and improve the mechanical and thermo-mechanical strength of the structure according to the invention.

In the filter structures according to the invention, the density of the channels is typically between about 1 and about 280 channels per cm² and preferably between 15 and 65 channels per cm².

In the filter structures according to the invention, the average wall thickness is preferably between 100 and 1000 microns, preferably between 100 and 700 microns.

In general, the width a of the outlet channels is between 0.05 mm and 4.00 mm, preferably between 0.10 mm and 2.50 mm, and very preferably between 0.20 mm and 2.00 mm.

In general, the width b of the inlet channels is between 0.05 mm and about 4 mm, preferably between 0.10 mm and 2.50 mm, and very preferably between 0.20 mm and 2.00 mm.

According to one embodiment, the walls are based on silicon carbide and/or on aluminum titanate and/or cordierite and/or mullite and/or silicon nitride and/or sintered metals.

The invention relates in particular to an assembled filter comprising a plurality of filtering structures as described above, said structures being bonded together by a cement, preferably of ceramic and refractory nature.

The invention further relates to the use of a filter structure or of an assembled filter as described above as a device on an exhaust line of a diesel or gasoline engine, preferably a diesel engine.

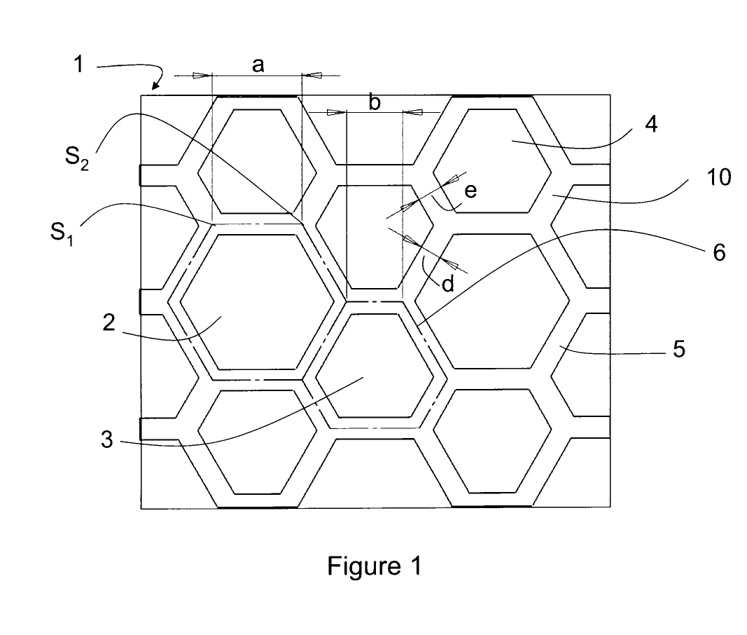

FIGS. 1 to 5 illustrate 5 nonlimiting embodiments of a filtering structure having a channel configuration according to the invention.

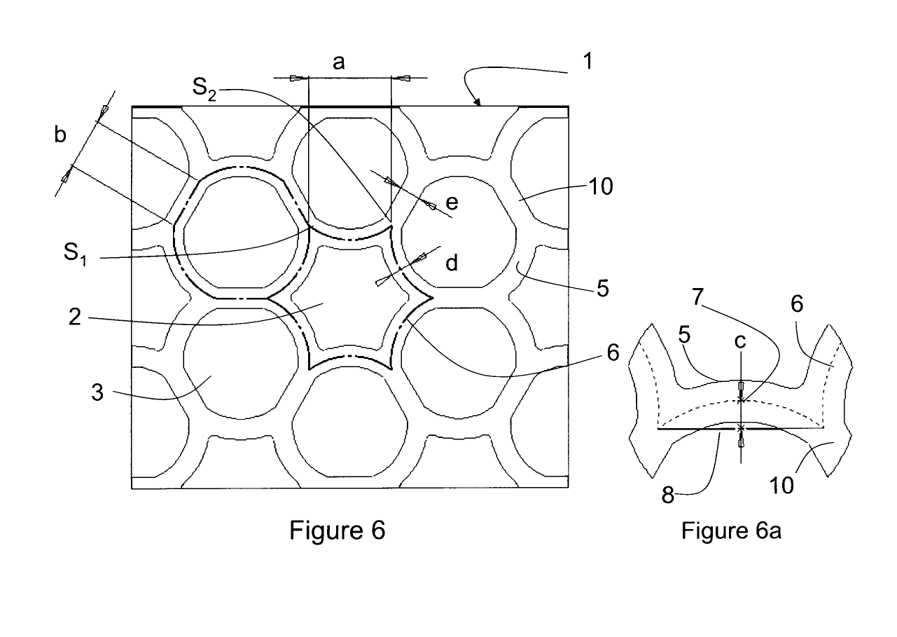

FIG. 6 illustrates an embodiment not according to the invention in which the thickness of all the walls is constant.

More precisely, FIG. 1 is a front elevation view of the front face of a filter according to a first embodiment of the invention, comprising inlet and outlet channels having six walls, in which said walls are plane and of constant thickness.

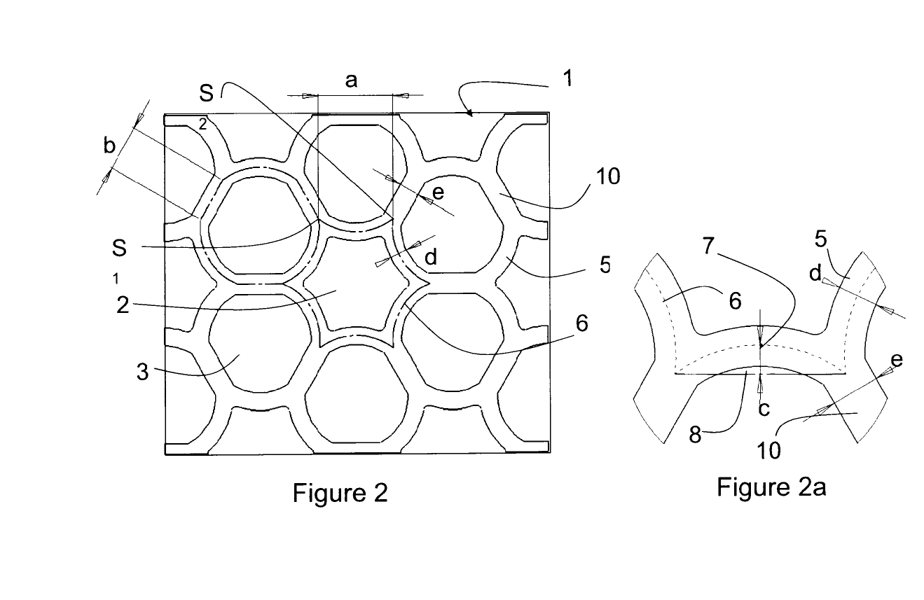

FIG. 2 is an elevation front view of the front face of a filter according to a second embodiment of the invention, comprising inlet and outlet channels having six walls, in which said walls are wavy, the outlet channels consisting of walls that are convex relative to the center of an outlet channel. FIG. 2a illustrates a more detailed view of FIG. 2.

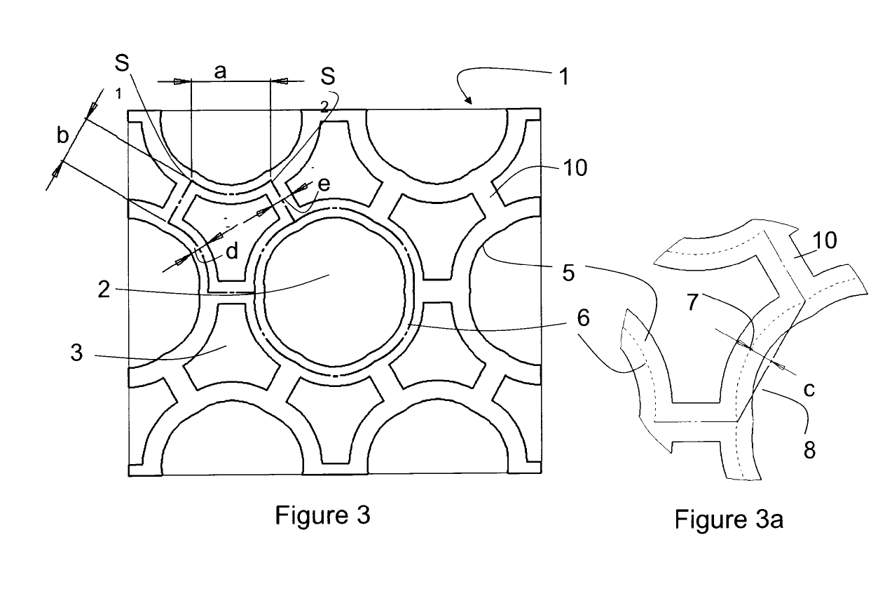

FIG. 3 is an elevation front view of the front face of a filter according to a third embodiment of the invention, comprising inlet channels having three walls and outlet channels having six walls, in which said walls are wavy, the outlet channels consisting of walls that are concave relative to the center of an outlet channel. FIG. 3a illustrates a more detailed view of FIG. 3.

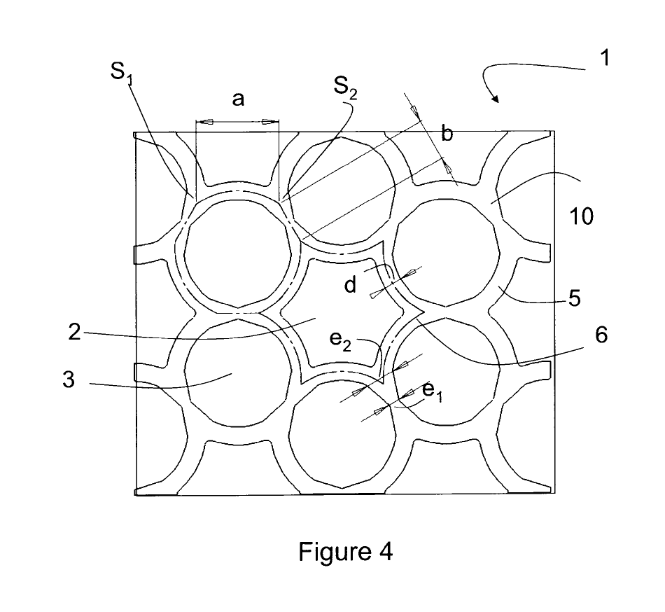

FIG. 4 is an elevation front view of the front face of a filter according to a fourth embodiment in which the walls common to the inlet channels have a variable thickness, especially a maximum thickness e₂ and a minimum thickness e₁.

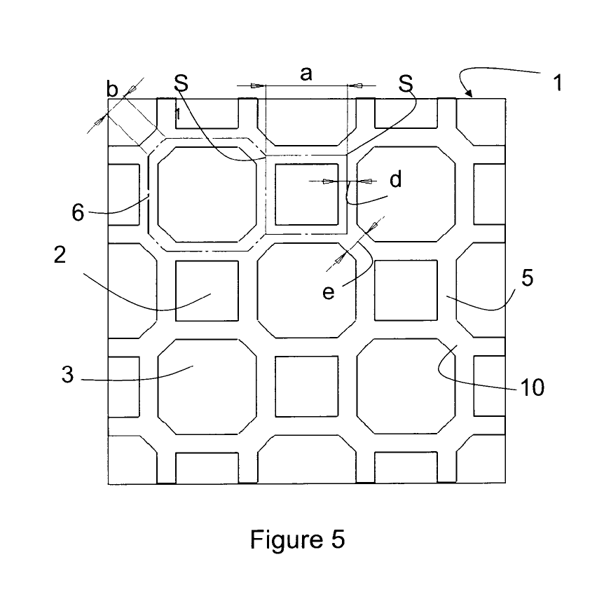

FIG. 5 is an elevation front view of the front face of a filter according to a fifth embodiment of the invention, comprising outlet channels having four walls on the one hand and inlet channels having eight walls.

FIG. 6 is an elevation front view of the front face of a filter not according to the invention, in which, unlike the filter described in relation to FIG. 2, the thickness e of the walls common to the inlet channels is identical to the thickness d of the common walls between the inlet and outlet channels. FIG. 6a illustrates a more detailed view of FIG. 6.

FIG. 1 shows an elevation view of the gas entry face of a portion of the monolith filtration unit 1. The unit has inlet channels 3 and outlet channels 2. The outlet channels are conventionally closed off on the gas entry face by plugs. The inlet channels are also blocked, but on the opposite (rear) face of the filter, so that the gases to be purified are forced to pass through the porous walls 5 common to the inlet and outlet channels. According to this first embodiment, the filtering structure is characterized by the presence of an outlet channel 2, the cross section of which has a regular hexagonal shape, that is to say the six sides of the hexagon are of substantially identical length a and two adjacent sides make an angle close to 120°. A regular outlet channel 2, thus formed by six walls of identical width a placed at 120° to one another, is in contact with six inlet channels 3 again of hexagonal general shape, but the hexagons are irregular, that is to say they are formed by adjacent walls at least two of which have a different width in cross section.

As shown in FIG. 1, two adjacent inlet channels 3 also have a common wall 10 of width b.

According to the invention, the thickness e of the walls 10 common to the inlet channels is greater than the thickness d of the common walls 5 between the inlet and outlet channels.

More particularly, the structures are characterized in that the e/d ratio is greater than 1 but preferably less than or equal to 10, or even less than or equal to 4.

As shown in FIGS. 1 to 6 appended hereto, in a front view (or cross section) of the filtering structure, the distances a and b are defined according to the invention as the distances joining the two vertices S₁ and S₂ of the wall in question, said vertices S₁ and S₂ being inscribed on the central core 6 of said wall (cf. FIG. 1 et seq.). Thus, a and b values independent of the wall thicknesses are obtained.

FIG. 2 shows the arrangement of an array of gas inlet channels 2 and gas outlet channels 3 in an elevation view of the entry face for the gases to be purified in a honeycomb structure according to the invention, the walls of which are wavy. Within this structure, as shown in FIG. 2a, the maximum distance c in cross section is defined as the distance between the extreme point 7 on the central core 6 of a wavy wall and the straight segment 8 joining the two ends S₁ and S₂ of the wall. According to the invention, the thickness e of the walls common to the inlet channels is greater than the thickness d of the common walls between the inlet and outlet channels.

FIG. 3 is an elevation front view of the front face of a filter according to a third embodiment of the invention comprising inlet channels having three walls and outlet channels having six walls, and in which the walls of the inlet and outlet channels are wavy, the outlet channels consisting of walls that are concave relative to the center of an outlet channel. Here again, and according to the invention, the thickness e of the walls common to the inlet channels is larger than the thickness d of the common walls between the inlet and outlet channels. FIG. 3a illustrates a more detailed view of FIG. 3.

In FIGS. 3 and 3a et seq., the same numbers are used to denote elements that are identical or similar to those already described in FIGS. 1, 2 and 2a. The definitions of the parameters a, b and c are also the same as explained above in relation to FIGS. 1, 2 and 2a.

FIG. 4 is an elevation front view of the front face of a filter according to a fourth embodiment according to an embodiment of the invention similar to that already described in relation to FIG. 2, but the walls 10 common to the inlet channels 3 have this time a variable thickness, especially a maximum thickness e₂ at the ends of said wall 10 and a minimum thickness e₁ in the middle of said wall 10. According to the invention, the average thickness eₐᵥ of said wall 10 is however greater than the average thickness d of the wall 5, even though the thickness e₁, taken at the middle of the wall 10, is locally smaller than the thickness d as shown in FIG. 4.

FIG. 5 is an elevation front view of the front face of a filter according to a fifth embodiment of the invention, comprising outlet channels having four walls on the one hand and inlet channels having eight walls. The inlet channels 3 and outlet channels 2 have four common walls that define said outlet channels, the walls of the inlet and outlet channels being plane. The walls common to the inlet channels 10 make an angle close to 45° with the common walls 5 between the inlet and outlet channels. As in the case of the previous examples, the thickness e of the walls 10 common to the inlet channels is greater than the thickness d of the common walls 5 between the inlet and outlet channels.

The invention and its advantages over the structures already known will be more clearly understood on reading the following nonlimiting examples.

### EXAMPLE 1

### Comparative Example

A first population of honeycomb-shaped monoliths made of silicon carbide was synthesized according to the prior art, for example that described in the patents EP 816 065, EP 1 142 619, EP 1 455 923 or WO 2004/090294.

To do this, according to the techniques described in particular in EP 1 142 619, 70% by weight of an SiC powder, the grains of which have a median diameter d₅₀ of 10 microns, was firstly mixed with a second SiC powder, the grains of which had a median diameter d₅₀ of 0.5 microns. Within the present description, the term “median pore diameter d₅₀” is understood to mean the diameter of the particles such that respectively 50% of the total population of the grains has a size smaller than this diameter. A pore former of polyethylene type was added to this mixture in a proportion equal to 5% by weight of the total weight of the SiC grains together with a shaping additive of methylcellulose type in a proportion equal to 10% by weight of the total weight of the SiC grains.

Water was then added and mixed until a uniform paste having a plasticity suitable for extrusion was obtained, the extrusion die being configured so as to obtain monolith blocks with an octagonal arrangement of the internal inlet channels (often called an “octosquare” structure in the field) as illustrated by FIG. 6b of application EP 1 495 791.

The green monoliths obtained were microwave-dried for a time long enough to bring the content of chemically non-bound water to less than 1% by weight.

The channels of each face of the monolith were alternately blocked using well-known techniques, for example those described in the application WO 2004/065088.

The monoliths were then fired in Argon with a temperature rise of 20° C./hour until a maximum temperature of 2200° C. was obtained, this being maintained for 6 hours. The porous material obtained had an open porosity of 47% and a median pore distribution diameter of around 15 microns.

The dimensional characteristics of the monoliths thus obtained are given in table 1 below, the structure having a periodicity, i.e. a distance between two adjacent channels, of 2.02 mm.

The arrangement of the channels is characterized by the following values, according to the previous description:
a=1.66 mm;
b=0.52 mm;
d=e=0.39 mm.

An assembled filter was then formed from the monoliths. Sixteen monoliths obtained from the same mixture were assembled together using conventional techniques by bonding using a cement having the following chemical composition: 72 wt % SiC, 15 wt % Al₂O₃, 11 wt % SiO₂, the remainder consisting of impurities, predominantly Fe₂O₃ and alkali and alkaline-earth metal oxides. The average thickness of the joint between two neighboring blocks is around 1 to 2 mm. The whole assembly was then machined so as to constitute assembled filters of cylindrical shape with a diameter of about 14.4 cm.

### EXAMPLE 2

### Comparative Example

The monolith synthesis technique described above was also repeated in the same way, but this time the die was designed so as to produce monolith blocks having a greater wall thickness, such that:
d=e=0.41 mm.

### EXAMPLE 3

### According to the Invention

The monolith synthesis technique described above was also repeated in the same way, but this time the die was designed so as to produce monolith blocks characterized by an octagonal arrangement of the internal inlet channels, as previously, but in which the thickness of the walls common to the inlet channels was larger than the thickness d of the common walls between the inlet and outlet channels, as illustrated by FIG. 5. The dimensional characteristics of the monoliths thus obtained are given in table 1 below, the structure having a periodicity, i.e. a distance between two adjacent channels, of 2.02 mm.

The arrangement of the channels is characterized by the following values, according to the previous description:
a=1.66 mm;
b=0.52 mm;
d=0.390 mm;
e=0.544 mm.

### EXAMPLE 4

### Comparative Example

The monolith synthesis technique described above was also repeated in the same way, but this time the die was designed to produce monolith blocks characterized by an arrangement of the internal channels according to the invention and in accordance with the representation given in FIG. 6, i.e. with wavy walls that are convex relative to the center of a regular outlet channel. The arrangement of the channels is characterized by the following values:
a=1.40 mm;
b=0.84 mm;
c=0.23 mm;
d=e=0.33 mm.

### EXAMPLE 5

### Comparative Example

The monolith synthesis technique described above was also repeated in the same way, but this time the die was designed to produce monolith blocks having a greater wall thickness such that:
d=e=0.348 mm.

### EXAMPLE 6

### According to the Invention

The monolith synthesis technique described above was also repeated in the same way, but this time the die was designed to produce monolith blocks characterized by an arrangement of the internal channels according to the invention and in accordance with the representation given in FIG. 2, i.e. with wavy walls that are convex in relation to the center of a regular outlet channel. The arrangement of the channels is characterized by the following values:
a=1.40 mm;
b=0.84 mm;
c=0.23 mm;
d=0.330 mm;
e=0.397 mm.

The main structural characteristics of the monoliths obtained according to examples 1 to 4 are given in table 1 below. The filter assembly/production technique was the same for all the examples and as described in example 1.

TABLE 1

| Examples | 1 | 2 | 3 | 4 | 5 | 6 |
|---|---|---|---|---|---|---|
| Channel | Comparative: | Comparative: | According to | Comparative: | Comparative: | According to |
| geometry | square- | square- | the invention | hexagonal | hexagonal | the invention |
| | octagonal | octagonal | (FIG. 5) | (FIG. 6) | (FIG. 6) | (FIG. 2) |
| Size of the | 36 | 36 | 36 | 36 | 36 | 36 |
| monoliths (mm) | | | | | | |
| Periodicity (mm) | 2.02 | 2.02 | 2.02 | 2.11 | 2.11 | 2.11 |
| Parameter a (mm) | 1.66 | 1.66 | 1.66 | 1.40 | 1.40 | 1.40 |
| Parameter b (mm) | 0.52 | 0.52 | 0.52 | 0.84 | 0.84 | 0.84 |
| Parameter c (mm) | NA | NA | NA | 0.23 | 0.23 | 0.23 |
| Length of the | 20.32 | 20.32 | 20.32 | 20.32 | 20.32 | 20.32 |
| monoliths (cm) | | | | | | |
| Thickness e of | 390 | 411 | 544 | 330 | 348 | 397 |
| the internal | | | | | | |
| walls (μm) | | | | | | |
| Thickness d of | 390 | 411 | 390 | 330 | 348 | 330 |
| the internal | | | | | | |
| walls (μm) | | | | | | |
| Inlet | 1/1 | 1/1 | 1/1 | 2/1 | 2/1 | 2/1 |
| channel/outlet | | | | | | |
| channel ratio | | | | | | |

NA = not applicable.

The specimens obtained were evaluated and characterized according to the following operating methods:

### A—Pressure Drop Measurement in the Soot-Free State:

The term “pressure drop” is understood within the present invention to mean the pressure difference that exists between the upstream and the downstream end of the filter. The pressure drop was measured using the standard techniques for a gas flow rate of 250 kg/h and a temperature of 250° C. on fresh filters.

### B—Thermo-Mechanical Strength Measurement:

The filters were mounted on an exhaust line of a 2.0-liter direct-injection diesel engine operating at full power (4000 rpm) for 30 minutes, after which they were removed and weighed so as to determine their initial mass. The filters were then put back on the engine test bed and run at a speed of 3000 rpm and a torque of 50 Nm for different times so as to obtain a soot load of 8 g/liter (by volume of the filter). The filters thus laden were put back on the line so as to undergo a severe regeneration thus defined: after stabilization at an engine speed of 1700 rpm for a torque of 95 Nm for 2 minutes, a post-injection is carried out with 70° of phase shift for a post-injection volume of 18 mm³/cycle. Once the soot combustion has been started, more precisely when the pressure drop decreases over at least 4 seconds, the engine speed is lowered to 1050 rpm for a torque of 40 Nm for five minutes so as to accelerate the soot combustion. The filter is then exposed to an engine speed of 4000 rpm for 30 minutes so as to remove the remaining soot.

The regenerated filters were inspected after being cut up, so as to reveal the possible presence of cracks visible to the naked eye. The thermo-mechanical strength of the filter was assessed according to the number of cracks, a low number of cracks representing an acceptable thermo-mechanical strength for use as a particulate filter.

As indicated in table 2, the following ratings were assigned to each of the filters:
+++: presence of very many cracks;
++: presence of many cracks;
+: presence of a few cracks;
−: no cracks or rare cracks.

The storage volume was determined using the usual techniques well known in the field.

### C—Evaluation of the Geometric Properties:

The OFA (open front area) was obtained by calculating the percentage ratio of the area covered by the sum of the cross sections of the inlet channels of the front face of the monoliths (excluding the walls and plugs) to the total area of the corresponding cross section of said monoliths. The residue storage volume is greater the higher this percentage.

The WALL is the ratio, in one cross section and as a percentage, of the area occupied by all of the walls of a monolith (excluding the plugs) to the total area of said cross section.

The specific filtration surface area of the filter (monolith or assembled filter) corresponds to the internal surface area of all of the walls of the inlet filtering channels expressed in m² relative to the volume of the filter in m³, where appropriate incorporating its external coating. The soot storage volume is greater the higher the specific surface area thus defined. The loading slope is lower the higher the specific filtration surface area.

The results obtained in the tests for all of examples 1 to 6 are given in table 2 below:

TABLE 2

| Examples | 1 | 2 | 3 | 4 | 5 | 6 |
|---|---|---|---|---|---|---|
| Channel | Comparative: | Comparative: | According to | Comparative: | Comparative: | According to |
| geometry | square- | square- | the invention | “hexa-wavy” | “hexa-wavy” | the invention |
| | octagonal | octagonal | (FIG. 5) | (FIG. 6) | (FIG. 6) | (FIG. 2) |
| Filtration | 904 | 895 | 873 | 1043 | 1034 | 1036 |
| surface area | | | | | | |
| (m²/m³) | | | | | | |
| OFA (%) | 47.2 | 46.3 | 45.6 | 49.0 | 48.1 | 47.6 |
| WALL (%) | 33.1 | 34.7 | 34.7 | 29.9 | 31.3 | 31.3 |
| Pressure drop | 39.1 | 41.9 | 40.1 | 36.8 | 38.9 | 37.6 |
| ΔP₀ (mbar) in | | | | | | |
| the fresh state or | | | | | | |
| the state free of | | | | | | |
| soot or residues | | | | | | |
| Presence of cracks | ++ | + | + | + | − | − |
| after 8 g/L soot | | | | | | |
| loading and severe | | | | | | |
| regeneration | | | | | | |

NA = not applicable.

Analysis of the Results:

The results given in table 2 show that the filters according to examples 3 and 6 according to the invention have the best compromise between the various desired properties in an application as a particulate filter in an automobile exhaust line. More particularly, the results show that the filters according to the invention have, for an identical WALL factor, a significantly lower pressure drop, while still maintaining, however, a filtration surface area and an OFA (representative of the soot storage volume) that are both very acceptable.

The results in table 2 also show that the filters according to the invention have a better thermo-mechanical strength than the comparative filters having the same internal wall thickness d.

The filter according to example 6 also has the lowest pressure drop in the fresh state at the same time as the highest filtration surface area among the examples provided.

In other words, the results given in table 2 indicate that the filtering structures obtained according to the invention have the best compromise, in particular between the two essential characteristics needed for an application as a particulate filter in an exhaust line, i.e. thermo-mechanical strength and pressure drop.

Such an improvement results in a longer potential lifetime of the filters, in particular in an automobile application, in which the residues arising from excessive soot combustion operations, during regeneration phases, have a tendency to accumulate until the filter is finally unusable.

More particularly, because of this better compromise, it becomes possible according to the invention to synthesize assembled structures from monoliths of larger size than hitherto, while still ensuring a longer lifetime.

1. A gas filter structure for filtering a particulate-laden gas, having a honeycomb pattern and comprising an assembly of longitudinal adjacent channels of mutually parallel axes separated by porous filtering walls, said channels being alternately blocked off at one or the other of the ends of the structure so as to define inlet channels and outlet channels for the gas to be filtered and so as to force said gas to pass through the porous filtering walls separating the inlet and outlet channels, wherein, in said structure:
the inlet and outlet channels share between them at least one wall of constant average thickness d over an entire length of the filter structure;
the inlet or outlet channels share between them at least one wall of constant average thickness e over the entire length of the filter structure; and
a ratio, e/d, is strictly greater than 1.

2. The gas filter structure as claimed in claim 1, in which:
each outlet channel comprises at least three walls of substantially identical width a, so as to form a channel having a cross section of substantially regular shape;
each outlet channel has a common wall with several inlet channels, each common wall is one side of said outlet channel; and
at least two inlet channels share a common wall of width b and average thickness e.

3. The gas filter structure as claimed in claim 1, in which the inlet and outlet channels are of hexagonal shape.

4. The gas filter structure as claimed in claim 1, in which the inlet channels are of triangular shape and the outlet channels are of hexagonal shape.

5. The gas filter structure as claimed in claim 1, in which the inlet channels are of octagonal shape and the outlet channels are of square shape.

6. The filter structure as claimed in claim 1, in which a ratio of average wall thicknesses e/d is greater than 1 but less than or equal to 10.

7. The filter structure as claimed in claim 1, in which the walls of the inlet and outlet channels are planar.

8. The filter structure as claimed in claim 1, in which the walls of the inlet and outlet channels are wavy, i.e. they have, in cross section and relative to the center of a channel, at least one concavity or at least one convexity.

9. The filter structure as claimed in claim 8, in which the outlet channels have walls that are convex relative to the center of said channels.

10. The filter structure as claimed in claim 8, in which the outlet channels have walls that are concave relative to the center of said channels.

11. The filter structure as claimed in claim 8, in which a maximum distance, over a cross section, between a point on the concave or convex wall(s) and the straight segment connecting the two ends of said wall is greater than 0 but less than 0.5a.

12. The filter structure as claimed in claim 1, in which the density of the channels is between about 1 and about 280 channels per cm².

13. The filter structure as claimed in claim 1, in which the average wall thickness is between 100 and 1000 microns.

14. The filter structure as claimed in claim 1, in which the width a of the outlet channels is between about 0.05 mm.

15. The filter structure as claimed in claim 1, in which the width b of the common wall between two inlet channels is between about 0.05 mm and about 4.00 mm.

16. The structure as claimed in claim 1, in which the walls comprise silicon carbide SiC and/or on aluminum titanate and/or cordierite and/or mullite and/or silicon nitride and/or sintered metals.

17. An assembled filter comprising a plurality of filtering structures as claimed in claim 1, wherein said structures are bonded together by a cement of ceramic and, optionally, refractory nature.

18. A process for manufacturing a pollution control system, the process comprising incorporating a filter structure or of an assembled filter as claimed in claim 1 into or onto an exhaust line of a diesel or gasoline engine.

19. The filter structure as claimed in claim 1, in which a ratio of average wall thicknesses e/d is equal to or greater than 1.05 but less than or equal to 5.

20. The filter structure as claimed in claim 1, in which a ratio of average wall thicknesses e/d is greater than or equal to 1.1 but less than or equal to 2.
